(19) United States
(12) Patent Application Publication
(10) Pub. No.: US 2009/0285264 A1
(43) Pub. Date: Nov. 19, 2009

(54) Method and System for Detection of Long Pulse Bin 5 Radars in the Presence of Greenfield Packets

(76) Inventors: Carlos Aldana, San Francisco, CA (US); David Lam, Fremont, CA (US)

Correspondence Address: MCANDREWS HELD & MALLOY, LTD, 500 WEST MADISON STREET, SUITE 3400, CHICAGO, IL, 60661, US

(21) Appl. No.: 12/464,732

(22) Filed: May 12, 2009

Related U.S. Application Data
(60) Provisional application No. 61/052,884, filed on May 13, 2008.

(51) Int. Cl. H04B 1/00; H04L 27/00

(52) U.S. Cl. 375/139; 375/342; 375/E01.001

(57) ABSTRACT

Aspects of a method and system for detection of long pulse bin 5 RADARs in the presence of Greenfield packets are presented. In one aspect of the system, a processor in a wireless communication device may receive a plurality of pulses via a received signal. The processor may select at least a portion of the received plurality of pulses. The processor may compute a time duration value and a pulse count value based on the selected at least a portion of the received plurality of pulses. The processor may determine whether the received signal comprises a RADAR transmission signal based on the computed time duration value and the computed pulse count value when the time duration value is greater than or equal to a threshold time duration value and the pulse count value is greater than or equal to a minimum pulse count threshold value.

### CROSS-REFERENCE TO RELATED APPLICATIONS/INCORPORATION BY REFERENCE

This application makes reference to, claims priority to, and claims the benefit of U.S. Application Ser. No. 61/052,884 filed May 13, 2008, which is hereby incorporated herein by reference in its entirety.

### FIELD OF THE INVENTION

Certain embodiments of the invention relate to wireless communication. More specifically, certain embodiments of the invention relate to a method and system for detection of long pulse bin 5 RADARs in the presence of Greenfield packets.

### BACKGROUND OF THE INVENTION

The Institute for Electrical and Electronics Engineers (IEEE), in resolution IEEE 802.11, also referred as “802.11”, has defined a plurality of specifications which are related to wireless networking in the 2.4 GHz and 5 GHz frequency bands. These 802.11 specifications, which include IEEE 802.11a and IEEE 802.11n specifications, establish standards for the operation of wireless communicating devices within wireless local area networks (WLAN). IEEE 802.11a comprises specifications for what are often referred to as legacy devices. Legacy devices may transmit signals utilizing single carrier modulation (SCM). IEEE 802.11n comprises specifications, which enable communicating devices to transmit signals utilizing orthogonal frequency division multiplexing (OFDM). IEEE 802.11n specifies other capabilities, which are incompatible with IEEE 802.11a-specified capabilities of legacy devices. Communicating devices, which utilize IEEE 802.11n-specified capabilities that are incompatible with legacy devices, are referred to as Greenfield devices.

Wireless devices communicate by transmitting data via one or more radio frequency (RF) signals. The transmitted RF signals may comprise one or more bursts of signal energy, which are transmitted at a specified carrier frequency, or at a plurality of carrier frequencies, within an RF channel bandwidth. For example, when a wireless device communicates utilizing the 5 GHz frequency band, a carrier frequency, f_{c}, may be between 5 GHz and 6 GHz. Each burst may comprise a specified burst time duration and may comprise one or more pulses, which are transmitted during the burst time duration. Each pulse may comprise a signal level, which represents encoding of one or more data bits. The correspondence between the signal level and the bit encoding may be determined based on a modulation type from which the given signal level is determined.

The 5 GHz frequency band, which is utilized by IEEE 802.11 devices, or station devices (STAs), may overlap with a frequency band, which has been allocated for C-band RADAR transmission and, for example, utilized for satellite communication. Consequently, the STAs, which are operating in the 5 GHZ frequency band may interfere with C-band RADAR transmission. Dynamic frequency selection (DFS) is a process, which may be utilized by the STAs to avoid transmitting signals that may interfere with RADAR signal transmissions. For example, in instances when a STA, which is transmitting signals at a selected RF frequency, detects potential RADAR signal transmission at that selected RF frequency, the STA may select a subsequent RF frequency to avoid interference with the potential RADAR signal transmission. The STA may transmit subsequent signal via the selected subsequent RF channel.

Since signal transmission by Greenfield devices may be incompatible with legacy devices, in instances when a legacy device is transmitting signals at a selected RF frequency and a Greenfield device is transmitting signals also at that RF frequency, the legacy device may detect the signal transmission from the Greenfield device and incorrectly detect a RADAR signal transmission. This may cause the legacy device to select a subsequent RF frequency based on a false RADAR signal determination.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for detection of long pulse bin 5 RADARs in the presence of Greenfield packets, substantially as shown in and/or described in connection with at least one of the figures, as set forth more completely in the claims. These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for wireless data communication, in accordance with an embodiment of the invention.

FIG. 2 is an exemplary diagram illustrating an exemplary transceiver system for wireless communication, in accordance with an embodiment of the invention.

FIG. 3 is an exemplary illustration of a pulse train, in accordance with an embodiment of the invention.

FIG. 4A is a flowchart that illustrates exemplary steps for detection of BIN 5 RADAR signal transmission in the presence of potential Greenfield signal transmission, in accordance with an embodiment of the invention.

FIG. 4B is a flowchart that illustrates exemplary steps for detection of BIN 5 RADAR signal transmission in the presence of potential Greenfield signal transmission in continuation of FIG. 4A, in accordance with an embodiment of the invention.

FIG. 4C is a flowchart that illustrates exemplary steps for detection of BIN 5 RADAR signal transmission in the presence of potential Greenfield signal transmission in continuation of FIG. 4B, in accordance with an embodiment of the invention.

### DETAILED DESCRIPTION OF THE INVENTION

Certain embodiments of the invention relate to a method and system for detection of long pulse bin 5 RADARs in the presence of Greenfield packets. Various embodiments of the invention comprise a method and system by which a legacy device may distinguish Greenfield device signal transmissions from RADAR signal transmissions.

One aspect of the invention may comprise determining a time duration value, PULSE_WIN, over which a plurality of pulses has been received at a receiving STA. The number of pulses in the plurality of pulses may be determined. In instances where the number of received pulses is less than a minimum pulse count threshold value, MIN_PULSE_THRESH, the receiving STA may determine that RADAR signal transmission has not been detected. In instances where the PULSE_WIN duration value is less than a threshold time duration value, MIN_WIN, and the number of received pulses is not less than a maximum pulse count threshold value, MAX_PULSE_THRESH, the receiving STA may determine that an incompatible signal has been received but the incompatible signal is determined to be a non-RADAR signal. In instances where the PULSE_WIN duration is not less than the MIN_WIN threshold duration value and the number of received pulses is not less than the MIN_PULSE_THRESH threshold value, the receiving STA may determine that a RADAR signal has been detected. In instances when the receiving STA has detected a RADAR signal, the receiving STA may select an RF frequency for STA signal transmission and/or reception to avoid potential interference with the detected RADAR signal transmission. The STA may comprise an access point (AP), which is operable to communicate with one or more other STAs in a WLAN basic service set (BSS). The AP may also be operable for communicating with other APs in an extended service set (ESS).

The sequence of bursts, which are transmitted in an RF signal, may follow observable patterns based on the type of data being transmitted. For example, bursts, which transmit voice of Internet protocol (VoIP) data may follow a characteristic pattern for VoIP data transmission. Bursts, which are transmitted in RADAR signals, may follow observable patterns. An exemplary pattern for RADAR signal transmission is referred to as Bin 5 RADAR. In various embodiments of the invention, the threshold values MIN_WIN, MIN_PULSE_THRESH and/or MAX_PULSE_THRESH may be set such that a receiving STA may be able to distinguish Bin 5 RADAR signal transmission from Greenfield signal transmissions, which carry VoIP data.

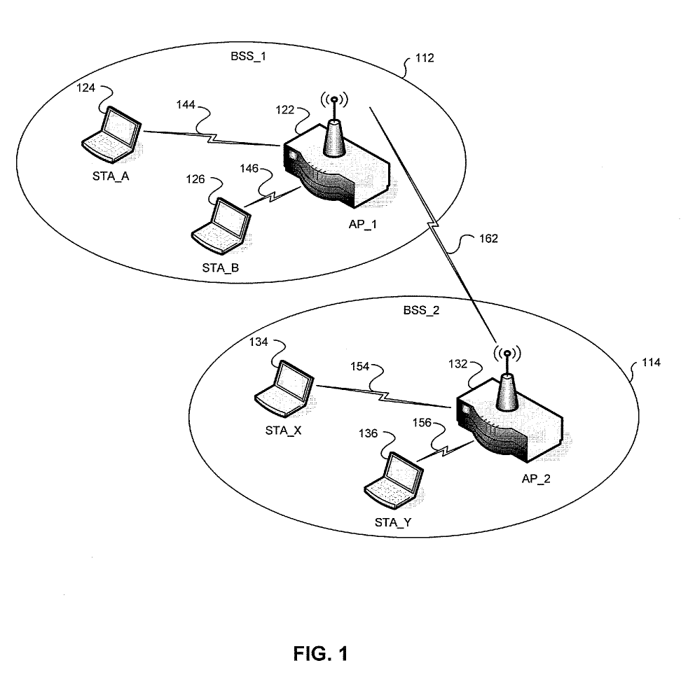

FIG. 1 is a block diagram of an exemplary system for wireless data communication, in accordance with an embodiment of the invention. Referring to FIG. 1, there is shown a BSS_1 112 and a BSS_2 114. The BSS_1 112 comprises an AP_1 122, a WLAN station STA_A 124 and an STA_B 126. The BSS_2 114 comprises an AP_2 132, an STA_X 134 and an STA_Y 136. The AP_1 122, STA_A 124 and STA_B 126 may comprise Greenfield devices. The AP_2 132, STA_X 134 and STA_Y 136 may comprise legacy devices.

Within the BSS_1 112, the AP_1 122 may communicate with the STA_A 124 via an RF channel 144. The AP_1 122 may communicate with STA_B 126 via an RF channel 146. The AP_1 122 may negotiate with the STA_A 124 to establish an RF channel assignment and RF channel bandwidth based on, for example, the transmission of beacon frames. Similarly, the AP_1 122 may negotiate with the STA_B 126 to establish an RF channel assignment and RF channel bandwidth based on, for example, the transmission of beacon frames. In an exemplary embodiment of the invention, the selected RF channel assignment for the RF channel 144 and/or the RF channel 146 may be within the 5 GHz frequency band. In an exemplary embodiment of the invention, VoIP data may be communicated via the RF channels 144 and 146.

Within the BSS_2 114, the AP_2 132 may communicate with the STA_X 134 via an RF channel 154. The AP_2 132 may communicate with STA_Y 136 via an RF channel 156. The AP_2 132 may negotiate with the STA_X 134 to establish an RF channel assignment and RF channel bandwidth based on, for example, the transmission of beacon frames. Similarly, the AP_2 132 may negotiate with the STA_Y 136 to establish an RF channel assignment and RF channel bandwidth based on, for example, the transmission of beacon frames. In an exemplary embodiment of the invention, the selected RF channel assignment for the RF channel 154 and/or the RF channel 156 may be within the 5 GHz frequency band.

The AP_2 132 may receive signals transmitted by the AP_1 122 via the RF channel 162. The AP_2 132 may determine that the signals received via the RF channel 162 may be incompatible with the capabilities of the AP_2 132. In an exemplary embodiment of the invention, the AP_2 132 may determine that, while the signals received via the RF channel 162 are incompatible with the capabilities of the AP_2 132, the received signals via the RF channel 162 may not comprise Bin 5 RADAR signal transmissions. Upon determining the characteristics of the signals received via the RF channel 162, the AP_2 132 may resume communications with the STA_X 134 and/or the STA_Y 136 while continuing to utilize currently assigned frequencies for the RF channel 154 and the RF channel 156.

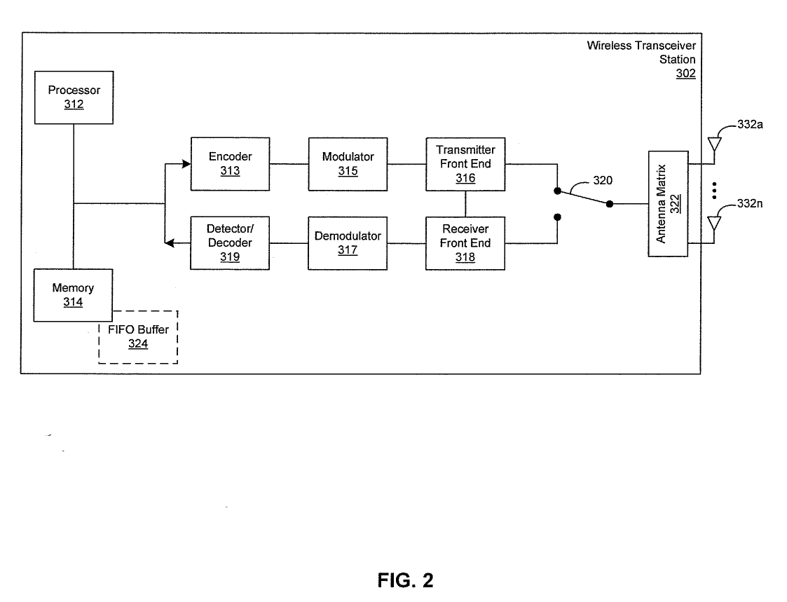

FIG. 2 is an exemplary diagram illustrating an exemplary transceiver system for wireless communication, in accordance with an embodiment of the invention. Referring to FIG. 2, there is shown a wireless transceiver station 302 and a plurality of antennas 332a . . . 332n. The wireless transceiver station 302 is an exemplary wireless communication device, which may be utilized as a transmitter and/or receiver. The AP_1 122, the AP_2 132, the STA_A 124, the STA_B 126, the STA_X 134 and/or the STA_Y 136 shown in FIG. 1 may comprise functions represented in the wireless transceiver station 302 in whole or in part. The plurality of antennas 332a . . . 332n may enable the wireless transceiver station 302 to transmit and/or receive signals, for example radio frequency (RF) signals, via a wireless communication medium. In an exemplary legacy device, the plurality of antennas 332a . . . 332n may enable the legacy device to utilize diversity reception. The wireless transceiver station 302 shown in FIG. 2 may also be depicted as comprising one or more transmitting antennas, which are coupled to the transmitter front end (FE) 316 and a separate one or more receiving antennas, which may be coupled to the receiver FE 318 without loss of generality.

The exemplary wireless transceiver station 302 comprises a processor 312, a memory 314, an encoder 313, a detector and decoder (detector/decoder) 319, a modulator 315 a transmitter FE 316, a demodulator 317, a receiver FE 318, a transmit and receive (T/R) switch 320 and an antenna matrix 322. The antenna matrix 322 may enable selection of one or more of the antennas 332a . . . 332n for transmitting and/or receiving signals at the wireless transceiver station 302. The T/R switch 320 may enable the antenna matrix 322 to be communicatively coupled to the transmitter FE 316 and/or the receiver FE 318 based on the switch position of the T/R switch 320. In an exemplary embodiment of the invention, the switch position of the T/R switch 320 may be determined based on configuration of the T/R switch 320 by the processor 312.

In operation, the processor 312 may comprise suitable logic, circuitry and/or code that are operable to configure the encoder 313, the decoder/detector 319, the modulator 315, the demodulator 317, the transmitter FE 316, the receiver FE 316, the T/R switch 320 and/or the antenna matrix 322 for signal transmission and/or reception. The processor 312 may be operable to store and/or retrieve data and/or code from the memory 314. The memory 314 may comprise suitable logic, circuitry and/or code that are operable to store data and/or code based on instructions received from the processor 312. The memory 314 may also be operable to output stored data and/or code based on instructions received from the processor 312.

The encoder 313 may receive data from the processor 312 and/or memory 314. The encoder 313 may comprise suitable logic, circuitry and/or code that are operable to generate encoded binary data based on the data received from the processor 312 and/or the memory 314. The encoded binary data may be generated utilizing error correction coding, for example binary convolutional coding (BCC), and/or bit interleaving. In an exemplary embodiment of the invention, the encoding of received data may be based on configuration of the encoder 313 by the processor 312. The modulator 315 may receive encoded binary data from the encoder 313. The modulator 315 may comprise suitable logic, circuitry and/or code that are operable to convert the encoded binary data to a data symbol representation based on one or more selected modulation types.

In an exemplary embodiment of the invention, a modulation type may be selected based on configuration of the modulator 315 by the processor 312. The modulator 315 may be operable to transmit the data symbols to the transmitter FE 316. The transmitter FE 316 may comprise suitable logic, circuitry, interface(s) and/or code that are operable to generate a pulse for each received signal. The pulse may be generated by upconverting each symbol by utilizing a frequency carrier signal, the frequency of which may be determined based on an RF channel assignment. In an exemplary embodiment of the invention, the frequency of the frequency carrier signal may be determined based on configuration of the transmitter FE 316 by the processor 312. The pulse may comprise RF signal energy, which may be transmitted via a wireless communication medium by one or more of the antennas 332a . . . 332n when the T/R switch 320 is configured to communicatively couple the transmitter FE 316 to the antenna matrix 322.

A group of symbols received from the modulator 315 by the transmitter FE 316 may be transmitted in a sequence of pulses referred to as a burst. The time duration, which begins at the start of the transmission of a pulse and ends at the start of transmission of a subsequent pulse is referred to as a pulse repetition interval (PRI). In various embodiments of the invention, there may be a minimum PRI threshold value, which may referred to as a MIN_PRI value. In an exemplary embodiment of the invention, MIN_PRI=150 microseconds (μs) The antenna matrix 322 may comprise suitable logic, circuitry and/or code that are operable to couple RF signal energy received from the transmitter FE 316 to a selected one or more antennas 332a . . . 332n. In an exemplary embodiment of the invention, one or more antennas 332a . . . 332n may be selected for transmission of RF signal energy based on configuration of the antenna matrix 322 by the processor 312.

The receiver FE 318 comprise suitable logic, circuitry, interface(s) and/or code that are operable to receive RF signal energy from signals received via one or more selected antennas 332a . . . 332n when the T/R switch 320 is configured to communicatively couple the receiver FE 318 to the antenna matrix 322. The receiver FE 318 may downconvert the received RF signal energy by utilizing a frequency carriers signal, the frequency of which may be determined based on an RF channel assignment. In an exemplary embodiment of the invention, the frequency of the frequency carrier signal may be determined based on configuration of the receiver FE 318 by the processor 312. The downconverted signal energy may comprise one or more pulses. Collectively, a plurality of received pulses may be referred to as a pulse train. Each of the pulses may comprise one or more signal energy levels, which corresponds to a data symbol. In an exemplary pulse, which is generated by utilizing frequency modulation, the pulse may comprise a time varying signal level, where the frequency at which the signal level varies is itself variable. The demodulator 317 may receive downconverted pulses from the receiver FE 318. The demodulator 317 may comprise suitable logic, circuitry and/or code that are operable to select a constellation point corresponding to a received pulse. The constellation point may be selected from a constellation map for a corresponding modulation type based on the signal level of the pulse and/or based on the rate of change in the signal level of the pulse. In an exemplary embodiment of the invention, a modulation type may be selected based on configuration of the demodulator 317 by the processor 312.

Based on the selected constellation point, the demodulator 317 may generate one or more bits. The detector/decoder 319 may receive downconverted pulses and generated bits from the demodulator 317. The detector/decoder 319 may comprise suitable logic, circuitry, interface(s) and/or code that are operable to detect the arrival of individual pulses. The detector/decoder 319 may generate descriptive data associated with each pulse. For example, the detector/decoder 319 may determine the time instant, which marks the start of the pulse, the time instant, which marks the end of the pulse. Based on the determined start time and end time of the pulse the detector/decoder 319 may determine a pulse width for the pulse. In addition, the detector/decoder 319 may determine the rate of change in the signal level of the pulse. Based on the determined rate of change in the signal level of the pulse, the detector/decoder 319 may determine a chirp rate for the pulse. Based on the determined chirp rate, the detector/decoder 319 may determine a corresponding fmin parameter value, where the fmin parameter is a measure that is related to the chirp rate.

The detector/decoder 319 may also utilize the determined start time and end time for each pulse to determine a PRI between successive pulses. The detector/decoder 319 may also generate decoded bits based on the bits received from the demodulator 317. The decoding of the received bits may be based on bit interleaving and/or bit encoding that was performed by an encoder 313, which was utilized in connection with the generation of transmitted signals that were subsequently received at the receiver FE 318. In an exemplary embodiment of the invention, the decoding of received bits may be based on configuration of the detector/decoder 319 by the processor 312. The determined pulse width, fmin value and decoded bits may be sent to the processor 312 and/or stored in the memory 314. In an exemplary embodiment of the invention, the memory 314 may comprise a first-in first-out (FIFO) buffer 324. The FIFO buffer 324 may be operable to store determined pulse width and fmin values for each detected pulse.

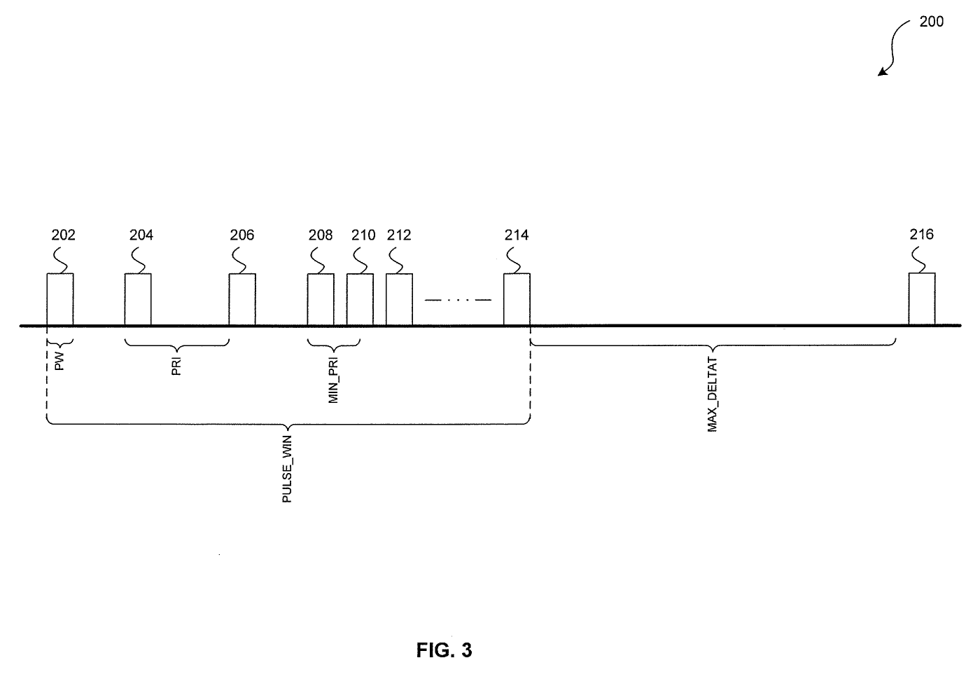

FIG. 3 is an exemplary illustration of a pulse train, in accordance with an embodiment of the invention. Referring to FIG. 3, there is shown a plurality of pulses 202, 204, 206, 208, 210, 212, 214 and 216, in a pulse train 200. Data may be stored in the memory 314 and/or FIFO buffer 324 for each pulse. For example, a pulse width (PW) value may be determined for each pulse. For example, FIG. 3 shows a PW value, which corresponds to the pulse 202. A PRI value may also be determined for successive pulses based on the stored data. For example, FIG. 3 shows a PRI value for the time duration that begins at the end of the pulse 204 and ends at the start of the pulse 206.

In various embodiments of the invention, a processor 312 may process stored data for the pulse train 200 to determine whether the pulse train 200 was received by RADAR signal transmission. In an exemplary embodiment of the invention, the processor 312 may attempt to detect Bin 5 RADAR signal transmissions. The processor 312 may read stored data from the memory 314 and/or FIFO buffer 324 at time instants that are determined based on a FIFO read time duration as represented by a read time interval value, T_READ. In an exemplary embodiment of the invention, T_READ=150 milliseconds (ms). Accordingly, the processor 312 may read stored pulse train data from the memory 314 and/or the FIFO buffer 324 every T_READ milliseconds.

In a transceiver station 302, which utilizes diversity reception, a given pulse may be received by a plurality of antennas 332a . . . 332n. The storing of data for each pulse may result in redundant pulse data being stored in the memory 314 and/or FIFO buffer 324. In various embodiments of the invention, the processor 312 may combine redundant pulse data based on the MIN_PRI value. FIG. 3 shows an exemplary MIN_PRI time duration. FIG. 3 also shows that the PRI between the pulse 208 and the pulse 210 is less than the MIN_PRI value. In various embodiments of the invention, the processor 312 may combine pulse data for the pulses 208 and 210. In an exemplary embodiment of the invention, the processor 312 may discard pulse data corresponding to the pulse 210. Discarding of pulse data may result in the corresponding pulse data being removed and/or deleted from the memory 314 and/or the FIFO buffer 324.

The processor 312 may also discard pulse data when the PRI value exceeds a maximum PRI threshold value, MAX_DELTAT. FIG. 3 shows an exemplary MAX_DELTAT time duration. In an exemplary embodiment of the invention, MAX_DELTAT=12 seconds (s). Based on the MAX_DELTAT value, the processor 312 may discard pulse data corresponding to the pulse 216. The processor 312 may determine a time duration, which comprises the pulses 202, 204, 206, 208, 210, 212 and 214. This time duration may correspond to a pulse window as represented by a PULSE_WIN value.

The processor 312 may utilize the stored pulse data for each of the pulses 202, 204, 206, 208, 210, 212 and 214 to determine a pulse width, PW, for each pulse. The processor may compare the PW value for each pulse to a minimum pulse width value, MIN_PULSE, and a maximum pulse width value, MAX_PULSE. In an exemplary embodiment of the invention, MIN_PULSE=20 μs and MAX_PULSE=100 μs. The processor 312 may discard pulses for which PW<MIN_PULSE or PW>MAX_PULSE.

The processor 312 may utilize the stored pulse data for each of the pulses, which were not discarded based on the PW value determination, to determine an fmin frequency value for each pulse. The determined fmin value may be compared to a minimum threshold frequency value, MIN_FMIN. In an exemplary embodiment of the invention, MIN_FMIN=15. The processor may discard pulses for which fmin<MIN_FMIN.

In various embodiments of the invention, pulses for which PW<MIN_PULSE or PW>MAX_PULSE or for which fmin<MIN_FMIN may be discarded by the detector/decoder 319 without having stored the corresponding pulse data in the memory 314 and/or FIFO buffer 324.

In various embodiments of the invention, the processor 312 may compare the PULSE_WIN value to a MIN_WIN value. In an exemplary embodiment of the invention, MIN_WIN=7 s. In addition, the processor may determine the number of pulses 202, 204, 206, 208, 210, 212 and 214, which are contained within the PULSE_WIN time duration. The number of pulses within the PULSE_WIN time duration may be represented by a PULSE_CT value. The processor 312 may compare the PULSE_CT value to a MIN_PULSE_THRESH value and to a MAX_PULSE_THRESH value. In an exemplary embodiment of the invention, MIN_PULSE_THRESH=6 and MAX_PULSE_THRESH=25.

In instances where PULSE_WIN≧MIN_WIN and PULSE_CT≧MIN_PULSE_THRESH, the processor 312 may determine that the pulse train 200 was received from a RADAR signal transmission. In response to the RADAR signal determination, the processor 312 may remove pulse data for the pulses 202, 204, 206, 208, 210, 212 and 214 from the memory 314 and/or the FIFO buffer 324. In addition, the processor 312 may configure the transmitter FE 316 and/or receiver FE 318 to select a subsequent RF channel assignment. The processor 312, which may be utilized in connection with the AP_2 132, may generate data for transmission to the STA_X 134 and/or STA_Y 136. The generated data may communicate the subsequent RF channel assignment.

In instances where PULSE_WIN<MIN_WIN and PULSE_CT≧MAX_PULSE_THRESH, the processor 312 may determine that the pulse train 200 was received from a Greenfield signal transmission, which transmits VoIP data, for example. In response to the Greenfield signal determination, the processor 312 may remove pulse data for the pulses 202, 204, 206, 208, 210, 212 and 214 from the memory 314 and/or the FIFO buffer 324.

In instances other than those described above, the processor 312 may process data contained in the pulses 202, 204, 206, 208, 210, 212 and/or 214.

Various embodiments of the invention may be practiced for varying configured values for the parameters T_READ, PRI, MIN_PRI, PULSE_WIN, MIN_PULSE, MAX_PULSE, MIN_FMIN, MIN_WIN, MIN_PULSE_THRESH, MAX_PULSE_THRESH and/or MAX_DELTAT, for example. Accordingly, various embodiments of the invention are not limited to the exemplary values presented herein for these parameters.

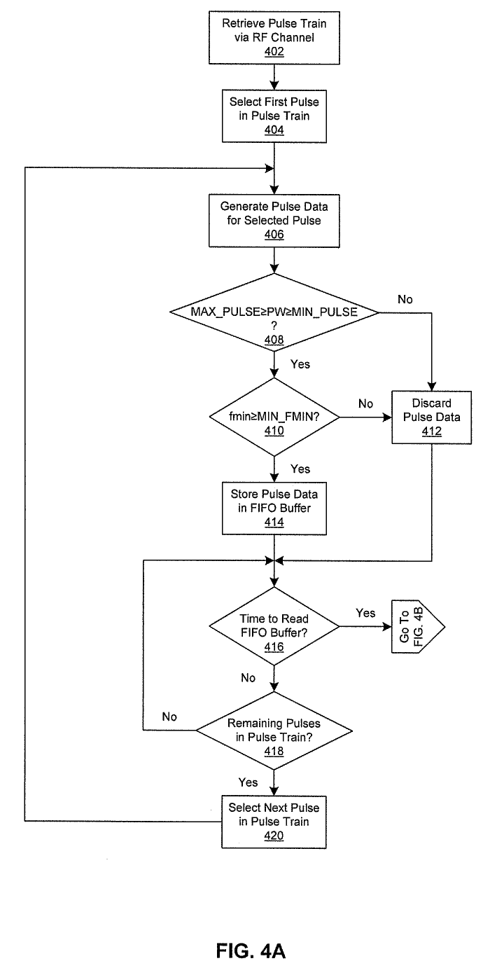

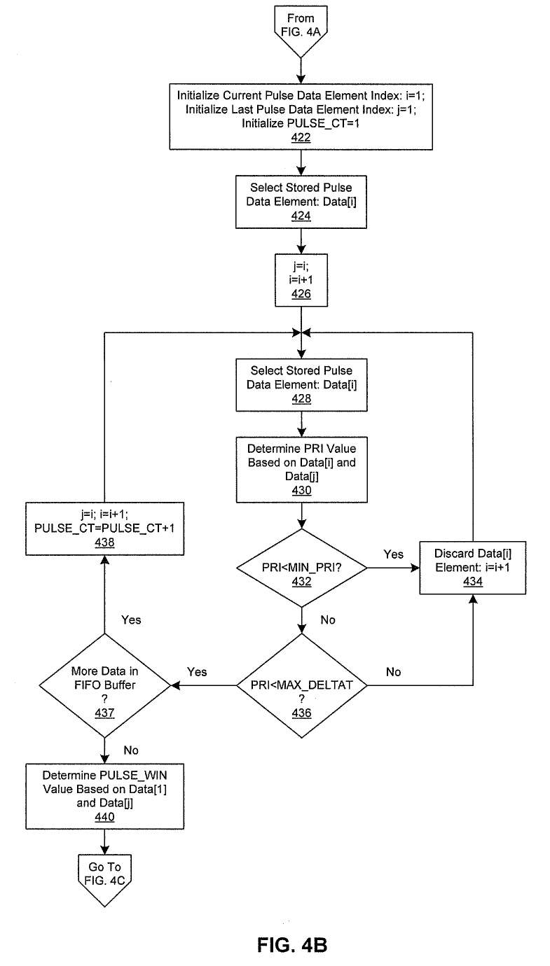

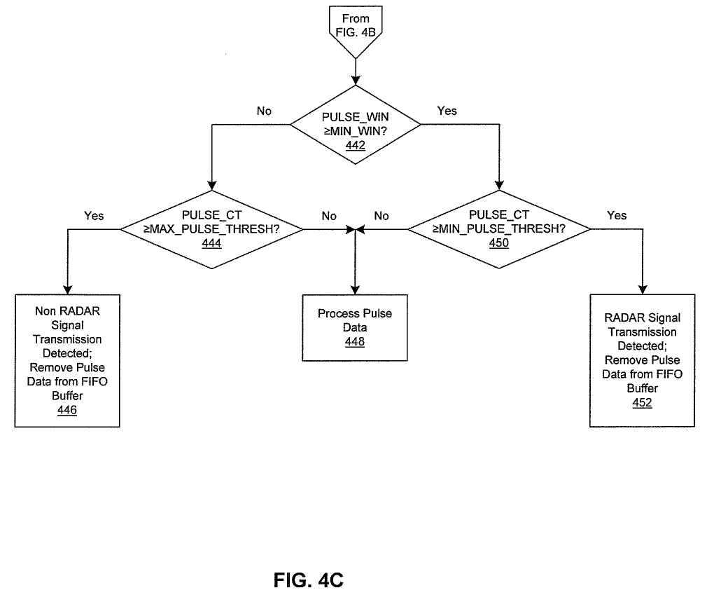

FIG. 4A is a flowchart that illustrates exemplary steps for detection of BIN 5 RADAR signal transmission in the presence of potential Greenfield signal transmission, in accordance with an embodiment of the invention. In an exemplary embodiment of the invention, a legacy AP_2 132 may attempt to distinguish Bin 5 RADAR signal transmission from Greenfield signal transmission. Referring to FIG. 4A, in step 402, an AP_2 may receive a pulse train 200 via RF signals transmitted in an RF channel 148. In step 404, a detector/decoder 319 may select a first pulse 202 in the received pulse train 200. In step 406, the detector/decoder 319 may generate pulse data for the selected pulse. The detector/decoder 319 may compute a pulse width value, PW, for the selected pulse. In step 408, the detector/decoder 319 may determine whether MAX_PULSE≧PW≧MIN_PULSE. In instances, at step 408, where the PW value indicates that the pulse width for the selected pulse is between the MAX_PULSE and MIN_PULSE values, in step 410, the detector/decoder 319 may determine whether an fmin value for the selected pulse is greater than or equal to the MIN_FMIN value. In instances, at step 410, where fmin≧MIN_FMIN, in step 414, the pulse data for the selected pulse may be stored in a FIFO buffer 324.

In step 416, the processor 312 may determine whether to read the stored contents of the FIFO buffer 324. In instances, in step 416, where the processor 312 determines to not read the FIFO buffer 324, in step 418, the detector/decoder 319 may determine whether there are remaining pulses to be processed in the pulse train 200. In instances, at step 418, where the detector/decoder 319 determines that there are no further pulses, step 416 may follow step 418. In instances, in step 418, where there are remaining pulses in the pulse train, in step 420, the detector/decoder 319 may select the next pulse 204, in the pulse train 200. Step 406 may follow step 420.

In instances, at step 408, where the PW value is not between the MAX_PULSE and MIN_PULSE values, in step 412, the detector/decoder 319 may discard the pulse data for the selected pulse. In instances, at step 410, where fmin is less than the MIN_FMIN value, step 412 may follow step 410. In instances, at step 416, where the processor 312 determines to read the FIFO buffer 324, further steps in the process may continue at FIG. 4B.

FIG. 4B is a flowchart that illustrates exemplary steps for detection of BIN 5 RADAR signal transmission in the presence of potential Greenfield signal transmission in continuation of FIG. 4A, in accordance with an embodiment of the invention. Referring to FIG. 4B, in step 422, the processor 312 may initialize a current pulse data element index, i=1, a last pulse data element index, j=1 and a pulse count value PULSE_CT=1. The current pulse data element index refers to pulse data that is stored in a FIFO buffer 324 for a current selected pulse. The last pulse data element index refers to pulse data that is stored in the FIFO buffer 324 for a preceding selected pulse. The PULSE_CT value maintains a count of the number of pulses in a PULSE_WIN time duration.

In step 424, the processor 312 may select a data element, Data[i], for the i^{th} pulse. The data element Data[i] may comprise pulse data that is stored in the FIFO buffer 324 for the i^{th} pulse. In step 426, the processor 312 may update index values i and j. The value j is set equal to the current value of the index i, after which the value of i may be incremented. In step 428, the processor may select a data element Data[i] based on the updated value for the index i. In step 430, the processor 312 may compute a PRI value that represents the time duration between the beginning of the pulse represented by Data[j] and the beginning of the pulse represented by Data[i]. In step 432, the processor 312 may determine whether the computed PRI value is less than the MIN_PRI threshold value. In instances, at step 432, where PRI<MIN_PRI, in step 434 the processor 312 may discard the pulse data for the current selected pulse, Data[i], after which the index value i may be incremented. Step 428 may follow step 434.

In instances, at step 432, where PRI≧MIN_PRI, in step 436, the processor 312 may determine whether PRI<MAX_DELTAT. In instances, at step 436, where PRI<MAX_DELTAT, in step 438, the processor 312 may update the index values i and j as described in step 426. In addition, the processor 312 may update the PULSE_CT value by incrementing the current PULSE_CT value. Step 428 may follow step 438.

In instances, at step 436, where PRI≧MAX_DELTAT, in step 437, the processor 312 may discard the pulse data Data[i] for the current selected pulse. In instances, at step 437, the processor may determine if there is more data in the FIFO buffer. In instances at step 437, if there is more data in the FIFO buffer, in step 438, the processor 312 may update the index values i and j as described in step 426. In instances at step 437, if there is no more data in the FIFO buffer, in step 440, the processor 312 may then compute a PULSE_WIN value based on pulse data for the first data element Data[1] and the pulse data Data[j] for a previous selected pulse. Further steps in the process may continue at FIG. 4C.

FIG. 4C is a flowchart that illustrates exemplary steps for detection of BIN 5 RADAR signal transmission in the presence of potential Greenfield signal transmission in continuation of FIG. 4B, in accordance with an embodiment of the invention. Referring to FIG. 4C, in step 442, the processor 312 may determine whether the PULSE_WIN value is greater than or equal to the MIN_WIN threshold value. In instances, at step 442, where PULSE_WIN<MIN_WIN, in step 444, the processor 312 may determine whether the PULSE_CT value is greater than or equal to a MAX_PULSE_THRESH threshold value. In instances, at step 444, where PULSE_CT≧MAX_PULSE_THRESH, at step 446, the processor 312 may determine that non-RADAR signal transmission has been detected. The processor 312 may instruct the memory 314 and/or FIFO buffer 324 to remove stored data for the received pulse train. In instances, at step 444, where PULSE_CT<MAX_PULSE_THRESH, at step 448, the processor 312 may continue processing the stored pulse data.

In instances at step 442, where PULSE_WIN≧MIN_WIN, in step 450, the processor 312 may determine whether the PULSE_CT value is greater than or equal to a MIN_PULSE_THRESH threshold value. In instances, at step 450, where PULSE_CT≧MIN_PULSE_THRESH, at step 452, the processor 312 may determine that RADAR signal transmission has been detected. The processor 312 may instruct the memory 314 and/or FIFO buffer 324 to remove stored data for the received pulse train. In instances, at step 450, where PULSE_CT<MIN_PULSE_THRESH, step 448 may follow step 450.

Another embodiment of the invention may provide a computer readable medium having stored thereon, a computer program having at least one code section executable by a computer, thereby causing the computer to perform steps as described herein for detection of long pulse bin 5 RADARs in the presence of Greenfield packets.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communicating information in a wireless communication system, the method comprising:
performing by one or more processors and/or circuits:
receiving a plurality of signal pulses via a received signal;
selecting at least a portion of said received plurality of signal pulses;
computing a time duration value and a pulse count value based on said selected at least a portion of said received plurality of signal pulses; and
determining whether said received signal comprises a RADAR transmission signal based on said computed time duration value and said computed pulse count value.

2. The method according to claim 1, comprising determining that said received signal comprises a RADAR signal transmission when said time duration value is greater than or equal to a threshold time duration value and said pulse count value is greater than or equal to a minimum pulse count threshold value.

3. The method according to claim 2, comprising discarding stored data for said selected at least a portion of said received plurality of signal pulses based on said determining.

4. The method according to claim 1, comprising discarding stored data for said selected at least a portion of said received plurality of signal pulses when said time duration value is less than a threshold time duration value and said pulse count value is greater than or equal to a maximum pulse count threshold value.

5. The method according to claim 1, comprising generating pulse data for each one of said received plurality of signal pulses, wherein said pulse data comprises a start time instant, an end time instant and a chirp rate.

6. The method according to claim 5, comprising computing a pulse width value for said each one of said received plurality of signal pulses based on corresponding pulse data.

7. The method according to claim 6, comprising selecting said selected at least a portion of said received plurality of signal pulses by selecting signal pulses among said received plurality of signal pulses for which said computed pulse width is greater than or equal to a minimum pulse width value and less than or equal to a maximum pulse width value.

8. The method according to claim 5, comprising selecting said selected at least a portion of said received plurality of signal pulses by selecting signal pulses among said received plurality of signal pulses for which a corresponding chirp rate corresponds to a frequency value that is greater than or equal to a minimum frequency threshold value.

9. The method according to claim 5, comprising computing a pulse repetition value for said each one of said received plurality of signal pulses based on corresponding pulse data for said each one of said received plurality of signal pulses and on corresponding pulse data for a preceding one of said received plurality of signal pulses.

10. The method according to claim 9, comprising selecting said selected at least a portion of said received plurality of signal pulses by selecting signal pulses among said received plurality of signal pulses for which a corresponding computed pulse repetition value is greater than or equal to a minimum pulse repetition interval threshold value and less than or equal to a maximum pulse repetition interval threshold value.

11. A system for communicating information in a wireless communication system, the system comprising:
one or more circuits that are operable to receive a plurality of signal pulses via a received signal;
said one or more circuits are operable to select at least a portion of said received plurality of pulses;
said one or more circuits are operable to compute a time duration value and a pulse count value based on said selected at least a portion of said received plurality of pulses; and
said one or more circuits are operable to determine whether said received signal comprises a RADAR transmission signal based on said computed time duration value and said computed pulse count value.

12. The system according to claim 11, wherein said one or more circuits are operable to determine that said received signal comprises a RADAR signal transmission when said time duration value is greater than or equal to a threshold time duration value and said pulse count value is greater than or equal to a minimum pulse count threshold value.

13. The system according to claim 12, wherein said one or more circuits are operable to discard stored data for said selected at least a portion of said received plurality of signal pulses based on said determining.

14. The system according to claim 11, wherein said one or more circuits are operable to discard stored data for said selected at least a portion of said received plurality of signal pulses when said time duration value is less than a threshold time duration value and said pulse count value is greater than or equal to a maximum pulse count threshold value.

15. The system according to claim 11, wherein said one or more circuits are operable to generate pulse data for each one of said received plurality of signal pulses, wherein said pulse data comprises a start time instant, an end time instant and a chirp rate.

16. The system according to claim 15, wherein said one or more circuits are operable to select a pulse width value for said each one of said received plurality of signal pulses based on corresponding pulse data.

17. The system according to claim 16, wherein said one or more circuits are operable to select said selected at least a portion of said received plurality of signal pulses by selecting signal pulses among said received plurality of signal pulses for which said computed pulse width is greater than or equal to a minimum pulse width value and less than or equal to a maximum pulse width value.

18. The system according to claim 15, wherein said one or more circuits are operable to select said selected at least a portion of said received plurality of signal pulses by selecting signal pulses among said received plurality of signal pulses for which a corresponding chirp rate corresponds to a frequency value that is greater than or equal to a minimum frequency threshold value.

19. The system according to claim 15, wherein said one or more circuits are operable to compute a pulse repetition value for said each one of said received plurality of signal pulses based on corresponding pulse data for said each one of said received plurality of signal pulses and on corresponding pulse data for a preceding one of said received plurality of signal pulses.

20. The system according to claim 19, wherein said one or more circuits are operable to select said selected at least a portion of said received plurality of signal pulses by selecting signal pulses among said received plurality of signal pulses for which a corresponding computed pulse repetition value is greater than or equal to a minimum pulse repetition interval threshold value and less than or equal to a maximum pulse repetition interval threshold value.
